(19) United States
(12) Patent Application Publication
(10) Pub. No.: US 2019/0013160 A1
(43) Pub. Date: Jan. 10, 2019

(54) KEYBOARD

(71) Applicant: Primax Electronics Ltd., Taipei (TW)

(72) Inventors: Hsiang-Wen Cheng, Taipei (TW); Tsu-Yi Chen, Taipei (TW); Chen-Hsuan Hsu, Taipei (TW)

(21) Appl. No.: 15/790,937

(22) Filed: Oct. 23, 2017

(30) Foreign Application Priority Data
Jul. 7, 2017 (TW) 106122890

(51) Int. Cl. H01H 13/10; H01H 13/70; H01H 13/14

(52) U.S. Cl. CPC H01H 13/10; H01H 13/14; H01H 13/70

(57) ABSTRACT

The present invention relates to a keyboard, including a base plate, a connecting element, a keycap, and a hook. The connecting element is separately connected to the hook and the base plate. The hook is disposed on an inner surface of the keycap and is connected to a connecting shaft of the connecting element. The hook includes a first fixing portion and a second fixing portion. The first fixing portion is in contact with a first side of the connecting shaft, and the second fixing portion is in contact with a second side of the connecting shaft. The structure of the second fixing portion in the hook is stronger than the structure of the first fixing portion, so that when the connecting shaft is applied with a force to be out of the hook, the first fixing portion is applied with an interference force to be broken, thereby having a recognizing effect.

### FIELD OF THE INVENTION

The present invention relates to an input apparatus, and in particular, to a keyboard including a plurality of key structures.

### BACKGROUND OF THE INVENTION

A common peripheral input apparatus of a computer includes a mouse, a keyboard, a track ball, and the like. The keyboard can be directly used for inputting a word and a symbol into the computer, and therefore gets great attention from users and input apparatus manufacturers. A relatively common keyboard is a keyboard including a plurality of key structures.

An architecture of the key structure in the keyboard is described below, and a key structure including a scissor-type connecting element is used as an example for description. Referring to FIG. 1, FIG. 1 is a schematic side cross-sectional view of a conventional key structure. The conventional key structure 1 includes a keycap 11, a scissor-type connecting element 12, an elastic rubber body 13, a thin film switch circuit 14, and a base plate 15, and the base plate 15 is used for carrying the keycap 11, the scissor-type connecting element 12, the elastic rubber body 13, and the thin film switch circuit 14. The scissor-type connecting element 12 is used for connecting the base plate 15 and the keycap 11.

The scissor-type connecting element 12 is located between the base plate 15 and the keycap 11 and is separately connected to the base plate 15 and the keycap 11. The scissor-type connecting element 12 includes a first frame 121 and a second frame 122. A first end of the first frame 121 is connected to the keycap 11, and a second end of the first frame 121 is connected to the base plate 15. The elastic rubber body 13 is encircled by the scissor-type connecting element 12, and the thin film switch circuit 14 has a plurality of key connection points (not shown). A corresponding key signal is output when each key connection point is triggered. The elastic rubber body 13 is disposed on the thin film switch circuit 14, and one elastic rubber body 13 corresponds to one key connection point. When being pressed, the elastic rubber body 13 is deformed and presses the corresponding key connection point in the thin film switch circuit 14 to generate a key signal.

An operation case in which the conventional key structure 1 is pressed by a user is described below. In FIG. 1, when the user presses the keycap 11, the keycap 11 is applied with a force to push the scissor-type connecting element 12 to move. Therefore, the keycap 11 can move downwards relative to the base plate 15 and presses the corresponding elastic rubber body 13. In this case, the elastic rubber body 13 is deformed and presses the thin film switch circuit 14 to trigger the key connection point of the thin film switch circuit 14, so that the thin film switch circuit 14 outputs a corresponding key signal. When the user stops pressing the keycap 11, the keycap 11 is not applied with the force any more and stops pressing the elastic rubber body 13, so that the elastic rubber body 13 restores its original shape due to elasticity and provides an upward elastic restoring force. In this way, the keycap 11 is pushed back to a location before the pressing. The foregoing is the architecture and the operation case of the conventional key structure.

After the keyboard is manufactured and assembled, the keycap is exposed outside, and consequently is easy to be separate from the scissor-type connecting element due to an external force factor. For example, the keycap is detached from the keyboard due to improper force application, the keycap is easy to be detached from due to inappropriate assembly of the keycap, and the like. When the keycap is detached from due to inappropriate assembly of the keycap, the structure of the keycap may be damaged in the process of being detached from the scissor-type connecting element, but it is difficult to realize from the appearance of the keycap. Although a keyboard manufacturer may perform product quality testing after the keyboard is assembled, it is difficult to find out that the structure of the keycap is already damaged, and the keyboard manufacturer may consider the keyboard as a good product. Later, the user finds out that the keycap is damaged after using the keyboard, and a customer complaint problem or a product change requirement may occur, causing increase of costs of keyboard manufacturing.

Therefore, a keyboard having a recognition function is required, to recognize whether the structure of a keycap is damaged.

### SUMMARY OF THE INVENTION

An objective of the present invention is to provide a keyboard having a recognition function.

In a preferred embodiment, the present invention provides a keyboard, including a base plate, a connecting element, a keycap, and a hook. The connecting element is located on the base plate and is connected to the base plate. The keycap is exposed outside the keyboard and is connected to the connecting element. The hook is disposed on an inner surface of the keycap, and is connected to a connecting shaft of the connecting element, so that the connecting shaft can rotate in the hook. The hook includes a first fixing portion and a second fixing portion. The first fixing portion is disposed on the inner surface of the keycap and is in contact with a first side of the connecting shaft. The second fixing portion is disposed on the inner surface of the keycap and is in contact with a second side of the connecting shaft. The structure of the second fixing portion is stronger than the structure of the first fixing portion.

In a preferred embodiment, the thickness of the first fixing portion is less than the thickness of the second fixing portion.

In a preferred embodiment, the width of the first fixing portion is less than the width of the second fixing portion.

In a preferred embodiment, the keycap has a cap edge, and the second fixing portion is connected to an inner side of the cap edge, so that the structure of the second fixing portion is strengthened by using the cap edge.

In short, the keyboard in the present invention is designed as that: the structure of the first fixing portion is weaker than the structure of the second fixing portion, so that it can be recognized whether the structure of the keycap is damaged. The following three manufacturing methods are included: First, a structure in which the thickness of the first fixing portion is less than the thickness of the second fixing portion is designed. Second, a structure in which the width of the first fixing portion is less than the width of the second fixing portion is designed. Third, a structure in which the second fixing portion is connected to the cap edge of the keycap and the first fixing portion is not connected to the cap edge is designed. In addition, an extension portion may be further disposed on the second fixing portion. Alternatively, an extension portion on the first fixing portion is removed, so that a structure in which the structure of the second fixing portion is stronger than the structure of the first fixing portion is formed.

### BRIEF DESCRIPTION OF THE DRAWINGS

FIG. 1 is a schematic side cross-sectional view of a conventional key structure;

FIG. 2 is a partial schematic structural view of a keyboard according to a first preferred embodiment of the present invention;

FIG. 3 is a partial schematic structural exploded view of a keyboard according to a first preferred embodiment of the present invention;

FIG. 4 is a schematic structural exploded view of a keycap of a keyboard from another perspective according to a first preferred embodiment of the present invention; and

FIG. 5 is a schematic structural exploded view of a keycap of a keyboard from another perspective according to a second preferred embodiment of the present invention.

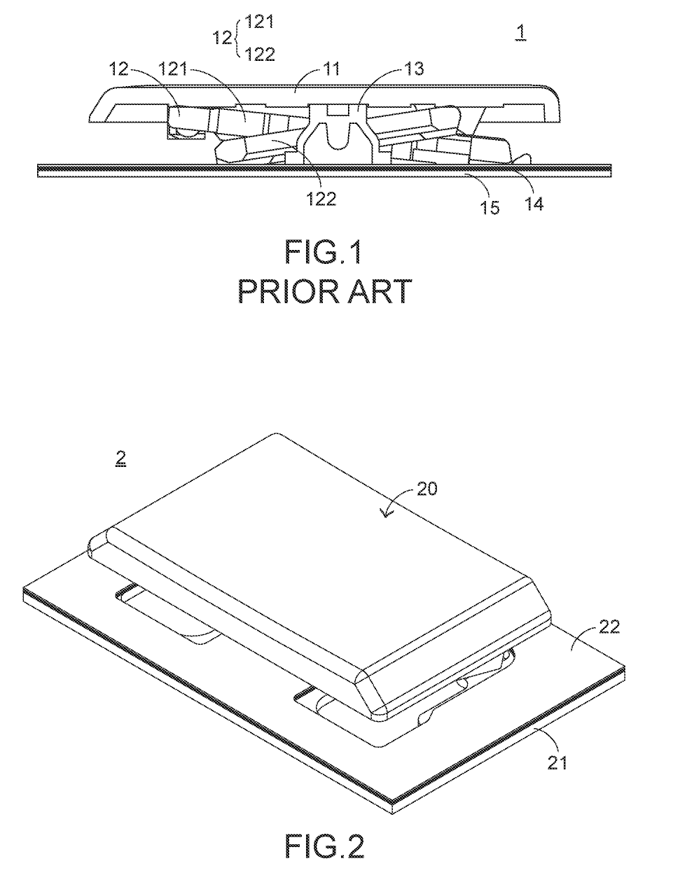

### DETAILED DESCRIPTION OF THE PREFERRED EMBODIMENT

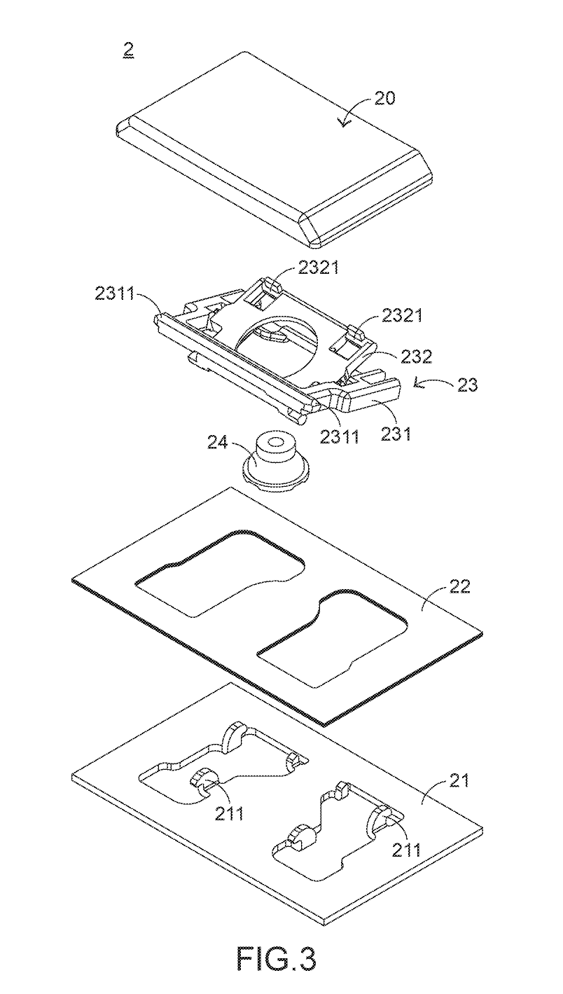

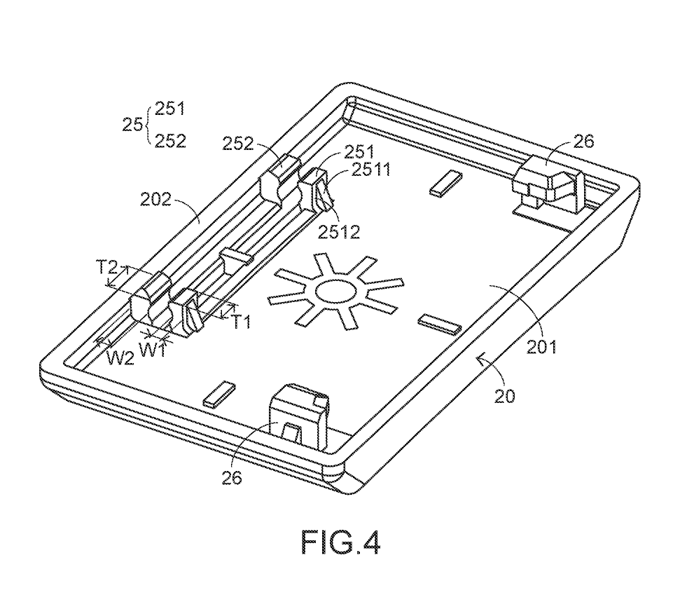

In view of the problem in the conventional technology, the present invention provides a keyboard that can resolve the problem in the conventional technology. The structure of the keyboard in the present invention is first described. Referring to FIG. 2 and FIG. 3 together, FIG. 2 is a partial schematic structural view of the keyboard according to a first preferred embodiment of the present invention, and FIG. 3 is a partial schematic structural exploded view of the keyboard according to the first preferred embodiment of the present invention. The keyboard 2 in the present invention includes a plurality of keycaps 20 (only one being shown), a base plate 21, a switch circuit board 22, a plurality of connecting elements 23 (only one being shown), a plurality of elastic elements 24 (only one being shown), a plurality of first hooks 25 (referring to FIG. 4), and a plurality of second hooks 26 (referring to FIG. 4). The base plate 21 is disposed below the plurality of keycaps 20, and is connected to the plurality of connecting elements 23. The plurality of connecting elements 23 is located on the base plate 21, and is respectively connected to the base plate 21 and the corresponding keycaps 20. Each keycap 20 is connected to the corresponding connecting element 23, and therefore can move relative to the base plate 21 when being pressed.

The switch circuit board 22 is located between the plurality of keycaps 20 and the base plate 21, and each elastic element 24 is located between the corresponding keycap 20 and the switch circuit board 22. When the keycap 20 is pressed by a user to move, the elastic element 24 is pushed by the keycap 20 to abut against the switch circuit board 22, so that the switch circuit board 22 outputs a corresponding key signal. In this preferred embodiment, the switch circuit board 22 is a thin film switch circuit, and the elastic element 24 is an elastic rubber body. The inner structure of the switch circuit board 22 is formed by an upper line board, a lower line board, and an isolating layer, this is known by a person skilled in the art, and details are not described herein.

In FIG. 3, the base plate 21 includes a plurality of base plate hooks 211. The plurality of base plate hooks 211 is disposed on an upper surface of the base plate 21, and has a function of being combined with the connecting elements 23. On the other hand, each connecting element 23 includes a first frame 231 and a second frame 232, a first end of the first frame 231 is connected to the keycap 20, and a second end of the first frame 231 is connected to the base plate hook 211 of the base plate 21. The second frame 232 is combined with the first frame 231, and can swing relative to the first frame 231, a first end of the second frame 232 is connected to the base plate hook 211 of the base plate 21, and a second end of the second frame 232 is connected to the keycap 20. The first frame 231 has a plurality of first connecting shafts 2311 disposed on the first end of the first frame 231, and the second frame 232 has a plurality of second connecting shafts 2321 disposed on the second end of the second frame 232. In this preferred embodiment, the connecting element 23 is a scissor-type connecting element.

Next, referring to FIG. 3 and FIG. 4 together, FIG. 4 is a schematic structural exploded view of the keycap of the keyboard from another perspective according to the first preferred embodiment of the present invention. FIG. 4 shows an inner surface 201 of the keycap 20, the plurality of first hooks 25, and the plurality of second hooks 26. The plurality of first hooks 25 is disposed on the inner surface 201 of the keycap 20 and is located on a first side of the keycap 20, and can be connected to the first connecting shaft 2311 of the connecting element 23, so that the first connecting shaft 2311 can rotate in the first hook 25. The plurality of second hooks 26 is disposed on the inner surface 201 of the keycap 20 and is located on a second side of the keycap 20, and can be connected to the second connecting shaft 2321 of the connecting element 23, so that the second connecting shaft 2321 can rotate in the second hook 26. In this preferred embodiment, the plurality of first hooks 25 and the plurality of second hooks 26 are respectively integrated with the keycap 20.

The first hook 25 includes a first fixing portion 251 and a second fixing portion 252. The first fixing portion 251 is in contact with a first side of the first connecting shaft 2311, and the second fixing portion 252 is in contact with a second side of the first connecting shaft 2311. It can be learned by means of comparison that the structure of the second fixing portion 252 is stronger than the structure of the first fixing portion 251. The following manufacturing method is used for the keyboard 2 in this preferred embodiment: the thickness T1 of the first fixing portion 251 is less than the thickness T2 of the second fixing portion 252, and the width W1 of the first fixing portion 251 is less than the width W2 of the second fixing portion 252. The width W1 of the first fixing portion 251 is defined as the width in a location having the smallest thickness in the first fixing portion 251, and the width W2 of the second fixing portion 252 is defined as the width in a location having the smallest thickness in the second fixing portion 252. In addition, the second fixing portion 252 is disposed on the inner surface 201 of the keycap 20, and is connected to a cap edge 202 of the keycap 20. Therefore, the structure of the second fixing portion 252 can be strengthened by means of the structure of the cap edge 202. Oppositely, the first fixing portion 251 is not connected to the cap edge 202 of the keycap 20. In this preferred embodiment, the first fixing portion 251 and the second fixing portion 252 are respectively integrated with the keycap 20.

By means of the structure of the plurality of base plate hooks 211, the plurality of first hooks 25, and the plurality of second hooks 26, the connecting element 23 can be separately connected to the base plate 21 and the keycap 20, so that the second frame 232 can swing relative to the first frame 231 and drive the keycap 20 to move up and down relative to the base plate 21. In the process of the keycap 20 moving up and down, the first connecting shaft 2311 rotates in the first hook 25, interference occurs between the first connecting shaft 2311 and the first hook 25, and the second connecting shaft 2321 can slide in the second hook 26.

An operation case in which the keycap 20 is pressed is described below. When a user presses any keycap 20, the keycap 20 moves downwards relative to the base plate 21, so that the connecting element 23 is pushed to swing, and the keycap 20 moving downwards pushes the elastic element 24, so that the elastic element 24 is abutted against to be deformed and to trigger the switch circuit board 22 to generate a corresponding key signal. When the user does not press the keycap 20 any more, the keycap 20 moves upwards relative to the base plate 21 due to an elastic force generated when the elastic element 24 recovers from a deformation state, the connecting element 23 is driven to swing to recover from a superposed state to an open state, and the keycap 20 recovers to a location before the pressing.

It should be particularly noted that, to maintain the structure of the first fixing portion 251 to be weaker than the structure of the second fixing portion 252, and to prevent the first fixing portion 251 from being excessively weak, the following manufacturing method for the keyboard 2 in the present invention is used: the first fixing portion 251 has an extension portion 2511 disposed between a side wall 2512 of the first fixing portion 251 and the inner surface 201 of the keycap 20, to strengthen the structure of the first fixing portion 251.

It can be learned from the foregoing that the structure of the second fixing portion 252 is stronger than the structure of the first fixing portion 251. When the user applies an improper force to the keycap 20, for example, pulls the keycap 20 up from the keyboard 2, and the first connecting shaft 2311 is applied with a force to be out of the first hook 25, the interference between the first connecting shaft 2311 and the first hook 25 is increased, that is, an interference amount between the first connecting shaft 2311 and the first hook 25 is increased, and consequently, the first fixing portion 251 is applied with a corresponding interference force to be broken. On the other hand, the second fixing portion 252 may be applied with the interference force. However, because the structure of the second fixing portion 252 is relatively strong, the second fixing portion 252 may not be broken.

By means of the structure of the keyboard 2 in the present invention, it can be recognized whether the user has performed an improper operation on the keycap 20, and this may be used as a basis whether a keyboard manufacturer will supply warranty. For a keyboard manufacturer, the structure of the keyboard 2 in the present invention facilitates an assembly operation of the keyboard 2: when the keycap is detached from due to inappropriate assembly of the keycap, and the structure of the keycap is damaged in the process of being detached from the scissor-type connecting element, the first fixing portion 251 is applied with a force to be broken. Therefore, it can be found out during a quality test that the structure of the keycap is already damaged, so as to avoid occurring of a quality testing error.

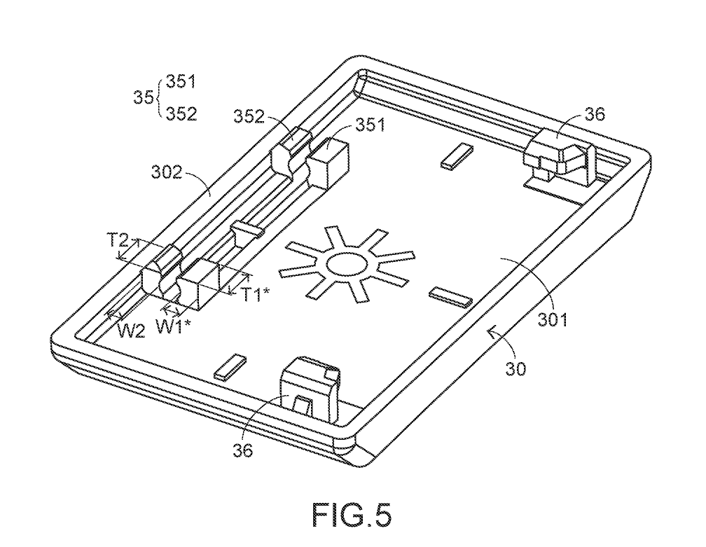

In addition, the present invention further provides a second preferred embodiment providing a different manufacturing method from the foregoing embodiment. Referring to FIG. 5, FIG. 5 is a schematic structural exploded view of a keycap of a keyboard from another perspective according to the second preferred embodiment of the present invention. FIG. 5 shows an inner surface 301 of a keycap 30, a plurality of first hooks 35, and a plurality of second hooks 36. The plurality of first hooks 35 is disposed on the inner surface 301 of the keycap 30 and is located on a first side of the keycap 30, and the plurality of second hooks 36 is disposed on the inner surface 301 of the keycap 30 and is located on a second side of the keycap 30. In this preferred embodiment, the structure of the keycap 30 is almost the same as the structure of the keycap 20 in the foregoing preferred embodiment, and a difference between the two is that the thickness T1* of the first fixing portion 351 is equal to the thickness T2 of the second fixing portion 352, the width W1* of the first fixing portion 351 is equal to the width W2 of the second fixing portion 352, and the first fixing portion 351 is not provided with an extension portion. On the other hand, the second fixing portion 352 is still connected to a cap edge 302 of the keycap 30, so as to strengthen the structure of the second fixing portion 352.

It should be particularly noted that the keyboard in the present invention is designed as that: the structure of the first fixing portion is weaker than the structure of the second fixing portion, so that it can be recognized whether the structure of the keycap is damaged. The following three manufacturing methods are included: First, a structure in which the thickness of the first fixing portion is less than the thickness of the second fixing portion is designed. Second, a structure in which the width of the first fixing portion is less than the width of the second fixing portion is designed. Third, a structure in which the second fixing portion is connected to the cap edge of the keycap and the first fixing portion is not connected to the cap edge is designed. In addition, the present invention may further provide a fourth manufacturing method for a keyboard: the extension portion in the foregoing first preferred embodiment may be disposed on the second fixing portion. Alternatively, the extension portion on the first fixing portion is removed, as described in this preferred embodiment. The first manufacturing method, the second manufacturing method, and the third manufacturing method are all used in the first preferred embodiment of the present invention, and the third manufacturing method and the fourth manufacturing method are used in the second embodiment. These are merely used as an example rather than a limitation. In another preferred embodiment, the structure in at least one of the first manufacturing method to the fourth manufacturing method may be used. In short, the structures in the first manufacturing method to the fourth manufacturing method may be separately used in the present invention. Alternatively, a combination of the structures in at least two of the first manufacturing method to the fourth manufacturing method may be used, so as to achieve an effect that the structure of the second fixing portion is stronger than the structure of the first fixing portion.

The foregoing descriptions are merely preferred embodiments of the present invention but are not intended to limit the application patent scope of the present invention. Therefore, any equivalent change or modification made without departing from the spirit disclosed in the present invention shall fall within the application patent scope of the present invention.

What is claimed is:

1. A keyboard, comprising:
a base plate;
a connecting element, located on the base plate and connected to the base plate;
a keycap, exposed outside the keyboard and connected to the connecting element; and
a hook, disposed on an inner surface of the keycap and connected to a connecting shaft of the connecting element, so that the connecting shaft can rotate in the hook, the hook comprising:
a first fixing portion, disposed on the inner surface of the keycap and in contact with a first side of the connecting shaft; and
a second fixing portion, disposed on the inner surface of the keycap and in contact with a second side of the connecting shaft, the structure of the second fixing portion being stronger than the structure of the first fixing portion.

2. The keyboard according to claim 1, wherein the thickness of the first fixing portion is less than the thickness of the second fixing portion.

3. The keyboard according to claim 1, wherein the width of the first fixing portion is less than the width of the second fixing portion.

4. The keyboard according to claim 1, wherein the keycap has a cap edge, and the second fixing portion is connected to an inner side of the cap edge, so that the structure of the second fixing portion is strengthened by using the cap edge.

5. The keyboard according to claim 1, wherein the hook further comprises an extension portion; and the extension portion is disposed between a side wall of the first fixing portion and the inner surface of the keycap, so as to strengthen the structure of the first fixing portion, or the extension portion is disposed between a side wall of the second fixing portion and the inner surface of the keycap, so as to strength the structure of the second fixing portion.

6. The keyboard according to claim 1, wherein the first fixing portion and the second fixing portion are respectively integrated with the keycap.

7. The keyboard according to claim 1, wherein when the connecting shaft is applied with a force to be out of the hook, an interference amount between the connecting shaft and the first fixing portion is increased, so that the first fixing portion is applied with a corresponding interference force to be broken.

8. The keyboard according to claim 1, wherein the connecting element comprises:
a first frame, a first end of the first frame being connected to the hook, and a second end of the first frame being connected to the base plate, wherein the connecting shaft is disposed on the first end of the first frame; and
a second frame, combined with the first frame and capable of swinging relative to the first frame, a first end of the second frame being connected to the base plate, and a second end of the second frame being connected to another hook of the keycap.

9. The keyboard according to claim 8, wherein the base plate comprises a plurality of base plate hooks, disposed on an upper surface of the base plate and configured to connect the second end of the first frame or connect the first end of the second frame.

10. The keyboard according to claim 1, further comprising:
a switch circuit board, located below the keycap and configured to output a key signal with moving of the keycap; and
an elastic element, located between the keycap and the switch circuit board and configured to abut against the switch circuit board when being pushed by the keycap, wherein when not being pushed by the keycap any more, the elastic element provides an elastic force for the keycap.
